(19) United States
(12) Patent Application Publication
(10) Pub. No.: US 2025/0147484 A1
(43) Pub. Date: May 8, 2025

(54) INFORMATION PROCESSING DEVICE, MACHINE TOOL, AND INFORMATION PROCESSING PROGRAM

(71) Applicant: DMG MORI CO., LTD., Nara (JP)

(72) Inventor: Takaya ONO, HOKKAIDO (JP)

(73) Assignee: DMG MORI CO., LTD., Nara (JP)

(21) Appl. No.: 18/837,009

(22) PCT Filed: Jan. 25, 2023
(86) PCT No.: PCT/JP2023/002213

§ 371 Date: Aug. 8, 2024

(30) Foreign Application Priority Data
Feb. 14, 2022 (JP) 2022-020153

(51) Int. Cl. G05B 19/4097; G05B 19/4069

(52) U.S. Cl. CPC G05B 19/4097; G05B 19/4069

(57) ABSTRACT

An information processing device of one aspect includes: a data acquisition unit that acquires model data or CL data output from a CAM; a specific information acquisition unit that acquires specific information of the CAM; a program generation unit that generates the NC program on the basis of the CL data; an input unit that accepts user input; a display control unit that displays one of a simulation image, a three-dimensional image, and a two-dimensional image on the basis of at least one of the NC program, the model data, and the CL data, and changes a display mode of the displayed image according to the user input; and an operability setting unit that changes the operability of the input unit for changing the display mode of the displayed image according to the operability of the CAM on the basis of the specific information acquired by the specific information acquisition unit.

### TECHNICAL FIELD

The present invention relates to a technique for adjusting operability of image display between software applications that transmit and receive model data.

### BACKGROUND ART

As a machine tool, e.g., a five-axis machine having three orthogonal straight axes (X axis, Y axis, and Z axis) and two rotating axes (B axis, C axis) is known. In such a machine tool, a numerical control device controls the five axes by executing an NC program (machining program) while changing the tip position and attitude of a tool to machine a workpiece into a desired shape.

NC programs are generated on the basis of tool location data (Cutter Location Data: hereafter referred to as CL data) obtained through computer-aided design (CAD) and computer-aided manufacturing (CAM). However, there are many models of numerical control devices, and different models have different specifications. Therefore, the CL data is appropriately converted by the CAM post-processor to provide an NC program optimized for each numerical control device.

### CITATION LIST

### Patent Literature

PTL 1: JP 2019-070953 A

### SUMMARY OF INVENTION

### Technical Problem

In general, post-processors are developed by CAM manufacturers or distributors. However, it is not easy for CAM manufacturers to develop post-processors that can be converted into NC programs that meet various specifications of each of numerical control devices.

Therefore, in recent years, manufacturers other than CAM manufacturers have been developing post-processors. However, the CAMs are of various different types. For this reason, the developers need to consider the possibility that post-processor users are accustomed to one of the CAMs. This is because CAM users tend to use the post-processor without customization procedure, and in that case, if there is a large difference of operability between the CAM and the post-processor, the difference will affect the user's workability.

That is, when CL data is converted into an NC program by the post-processor, a simulation screen of the manufacturing process may be displayed so that the user can check whether the NC program operates normally. Furthermore, there is a case in which model data of a products created by CAD is displayed for confirmation. In this case, the user conducts operations on these 3D models such as enlargement/reduction (scaling), translation, and rotation, among other operations. There is also a need to make the operability the same as the CAM operability to which the user is accustomed, rather than setting the operability specific to the post-processor.

### Solution to Problem

One aspect of the present invention is an information processing device that generates NC programs used in machine tools. This information processing device includes: a data acquisition unit that acquires model data or CL data output from a CAM; a specific information acquisition unit that acquires specific information of the CAM; a program generation unit that generates the NC program on the basis of the CL data; an input unit that accepts user input; a display control unit that displays one of a simulation image, a three-dimensional image, and a two-dimensional image on the basis of at least one of the NC program, the model data, and the CL data, and changes a display mode of the displayed image according to the user input; and an operability setting unit that changes the operability of the input unit for changing the display mode of the displayed image according to the operability of the CAM on the basis of the specific information acquired by the specific information acquisition unit.

Another aspect of the invention is a machine tool. This machine tool includes: a data acquisition unit that acquires model data and NC programs generated by an external device; a specific information acquisition unit that acquires specific information of the external device; an input unit that accepts user input; a display control unit that displays one of a simulation image, a three-dimensional image, and a two-dimensional image on the basis of at least one of the NC program and the model data, and changes a display mode of the displayed image according to the user input; and an operability setting unit that changes the operability of the input unit for changing the display mode of the displayed image according to the operability of the external device on the basis of the specific information acquired by the specific information acquisition unit.

Yet another aspect of the invention is an information processing program that generates NC programs used in machine tools. This program causes a computer to implement: a function to acquire model data or CL data output from a CAM; a function to acquire specific information of the CAM; a function to generate the NC program on the basis of the CL data; a function to accept user input via an input unit; a function to display one of a simulation image, a three-dimensional image, and a two-dimensional image on the basis of at least one of the NC program, the model data, and the CL data, and change the display mode of the displayed image according to the user input; and a function to change the operability of the input unit for changing the display mode of the displayed image according to the operability of the CAM on the basis of the acquired specific information.

### Advantageous Effects of Invention

The present invention can implement a similar operability between software applications that transmit and receive model data, thereby facilitating operation by the user.

### BRIEF DESCRIPTION OF DRAWINGS

FIG. 1 is a hardware configuration diagram of a machine tool according to an embodiment.

FIG. 2 is a functional block diagram of an information processing device.

FIG. 3 illustrates the difference in operability depending on the type of CAM.

FIGS. 4A to 4C illustrate an example of an operation to change the display mode of an image.

FIGS. 5A and 5B illustrate an example of an operation to change the display mode of an image.

FIG. 6 illustrates a specific example of operability change processing.

FIGS. 7A and 7B illustrate a specific example of operability change processing.

FIGS. 8A and 8B illustrate a specific example of operability change processing.

FIG. 9 is a flowchart illustrating operability setting processing.

FIG. 10 is a functional block diagram of an information processing device according to a modification.

### DESCRIPTION OF EMBODIMENTS

Embodiments of the present invention will be described below with reference to the drawings.

It should be noted that for the following embodiments and modifications thereof, nearly identical components are denoted by identical symbols and their descriptions are omitted as appropriate.

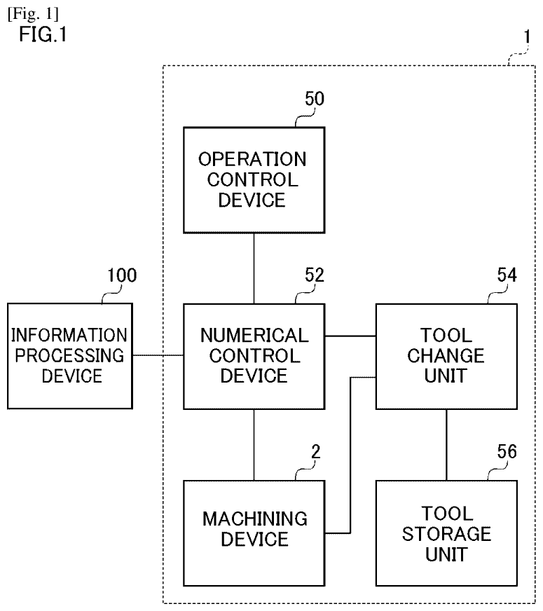

FIG. 1 is a hardware configuration diagram of a machine tool according to an embodiment.

The machine tool 1 is, e.g., a five-axis control machining center, and is provided with a machining device 2 having three orthogonal straight axes (X-axis, Y-axis, and Z-axis) and two rotating axes (B-axis and C-axis). These five axes are simultaneously controlled by a numerical control device 52 to move the tool tip end point, and various machining operations are performed while changing the tool attitude.

The machine tool 1 includes an operation control device 50, the numerical control device 52, the machining device 2, a tool change unit 54, and a tool storage unit 56. The numerical control device 52 transmits control signals to the machining device 2 according to an NC program generated manually or automatically. The machining device 2 machines a workpiece (not shown) by driving the spindle and the table of the machining device 2 according to the instructions from the numerical control device 52.

The operation control device 50 includes an operation panel that provides a user interface function to the operator. The operator controls the numerical control device 52 via the operation control device 50. The tool storage unit 56 stores tools. The tool change unit 54 corresponds to the so-called ATC (Automatic Tool Changer). The tool change unit 54 takes out a tool from the tool storage unit 56 according to the change instruction from the numerical control device 52, and changes the tool in the spindle with the tool taken out.

The numerical control device 52 is connected to an information processing device 100. The information processing device 100 generates an NC program on the basis of the CL data acquired from the CAM and outputs the generated NC program to the numerical control device 52. The numerical control device 52 executes this NC program to control the machining device 2. The information processing device 100 may be configured as a part of the operation control device 50. The information processing device 100 may be a general laptop PC (Personal Computer) or a tablet computer.

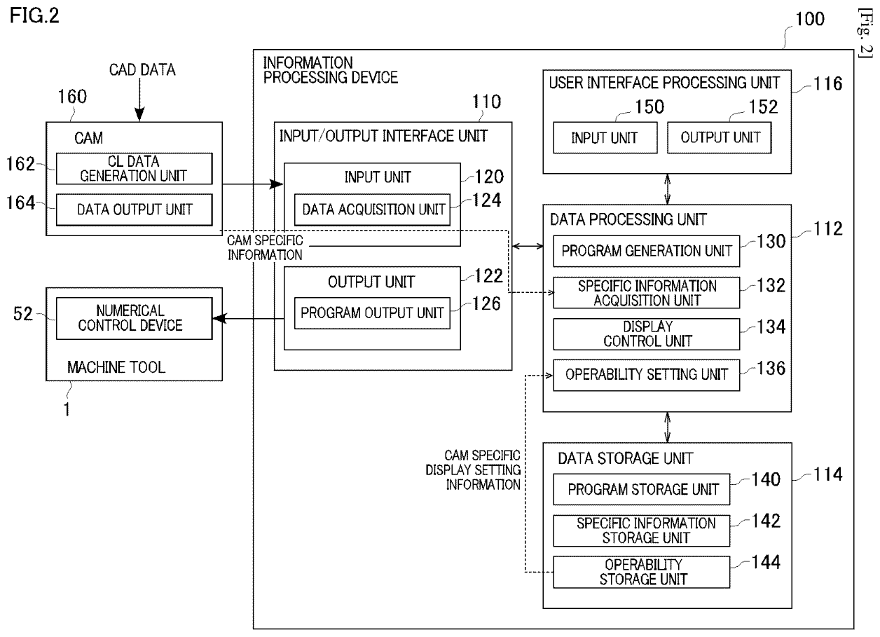

FIG. 2 is a functional block diagram of the information processing device 100 illustrating an example of the invention.

Each component of the information processing device 100 is implemented by hardware including computing units such as central processing units (CPUs) and various computer processors, a storage device such as memories and storages, and wired or wireless communication lines that connects these units and devices, and software that is stored in the storage devices and supplies processing instructions to the computing units. Computer programs may be constituted by device drivers, operating systems, various application programs on upper layers thereof, and a library that provides common functions to these programs. Each of the blocks described below represents a functional block, not a hardware block.

It should be noted that each component of the operation control device 50 and the numerical control device 52 may also be implemented in a form of hardware including a computing unit such as a processor, storage units such as memory and storage, and wired or wireless communication lines connecting them, and software stored in a storage device to supply processing instructions to the computing unit.

The information processing device 100 includes an input/output interface unit 110, a data processing unit 112, a data storage unit 114, and a user interface processing unit 116. The input/output interface unit 110 is responsible for processing related to the input/output interface, including data exchange with external devices. The data storage unit 114 stores various programs and setting data. The user interface processing unit 116 is responsible for processing related to the user interface, such as image display and audio output, in addition to accepting operations from the user.

The data processing unit 112 performs various processes on the basis of the data acquired by the input/output interface unit 110, the data stored in the data storage unit 114, and the data acquired by the user interface processing unit 116. The data processing unit 112 also functions as an interface for the input/output interface unit 110, the data storage unit 114, and the user interface processing unit 116.

The input/output interface unit 110 includes an input unit 120 and an output unit 122. The input unit 120 includes a data acquisition unit 124. The data acquisition unit 124 acquires CL data and model data from a CAM device 160. The output unit 122 includes a program output unit 126. The program output unit 126 outputs the NC program generated by the data processing unit 112 to the numerical control device 52.

The CAM device 160 acquires CAD data generated by a CAD device not shown, and acquires path generation information (coordinate system, tool shape, feed speed, and spindle rotational speed, among others). The CAM device 160 includes a CL data generation unit 162 and a data output unit 164. The CL data generation unit 162 generates CL data on the basis of the CAD data and the path generation information. The CL data includes the instructed position of the tool tip point and the instructed angle of the tool attitude.

The data output unit 164 outputs the generated CL data to the information processing device 100. The data output unit 164 also outputs the CAD data to the information processing device 100 as three-dimensional model data (also called “3D model data”).

The data storage unit 114 includes a program storage unit 140, a specific information storage unit 142, and an operability storage unit 144. The data storage unit 114 includes a memory that functions as a working area when the data processing unit 112 performs computing operations. The program storage unit 140 stores an information processing program for generating an NC program. The specific information storage unit 142 stores specific information of the CAM to be described later. The operability storage unit 144 stores information related to the operability for each type of CAM (described later in detail).

The user interface processing unit 116 includes an input unit 150 and an output unit 152.

The input unit 150 accepts operation input from the user via a hardware device such as a touch panel, various keys, or handles. The output unit 152 provides various information to the user via image display on the display unit or audio output.

The data processing unit 112 includes a program generation unit 130, a specific information acquisition unit 132, a display control unit 134, and an operability setting unit 136. The program generation unit 130 functions as a post-processor and generates an NC program on the basis of the CL data acquired by the data acquisition unit 124.

In this embodiment, considering the workability when the user of the CAM uses the post-processor without customization procedure, the operability of the CAM can be reflected in the drawing function of the post-processor. In other words, the information processing device 100 can change the operability of the processor depending on the type of CAM according to the user demand. The program storage unit 140 stores an information processing program for changing the operability of the input unit 150 for changing the display mode of the image in the post-processor in accordance with the operability of the CAM.

The specific information acquisition unit 132 acquires the specific information of the CAM possessed by the CAM device 160. The “specific information” here is set as information, e.g., the CAM name or ID, which can identify the type of CAM that generated the CL data. The specific information of the CAM is output from the CAM device 160 and acquired by the specific information acquisition unit 132 (see dotted line). The specific information storage unit 142 stores the acquired specific information. The operability storage unit 144 stores specific information for each type of CAM and operability information associated with it (described later in detail).

The display control unit 134 controls the display of images on a display unit (not shown). The display control unit 134 causes the display unit to display a three-dimensional image or a two-dimensional image of a workpiece, a product (semi-finished products, finished products, and parts), a tool, a device part including a spindle, and the like on the basis of the acquired model data according to the user input. Further, the display control unit 134 causes the display unit to display a simulation image representing the machining process of the workpiece on the basis of the CL data and the model data. The display control unit 134 changes the display mode (display position, display angle, display direction, and display size, among others) of the displayed image in response to user inputs.

The operability setting unit 136 acquires operability information corresponding to the specific information from the operability storage unit 144 according to user inputs. The CAM specific information stored in the specific information storage unit 142 is sent to the operability setting unit 136, and the CAM specific operability information stored in the operability storage unit 144 is sent to the operability setting unit 136. The operability setting unit 136 then changes the operability of the input unit 150 for changing the display mode of the image displayed on the display unit, in accordance with the operability of the CAM on the basis of the specific information. Here, “change in display mode” includes translation, rotation, change of viewpoint, and enlargement/reduction of the image, which will be described later.

Next, a method for changing the operability in the information processing device 100 is described.

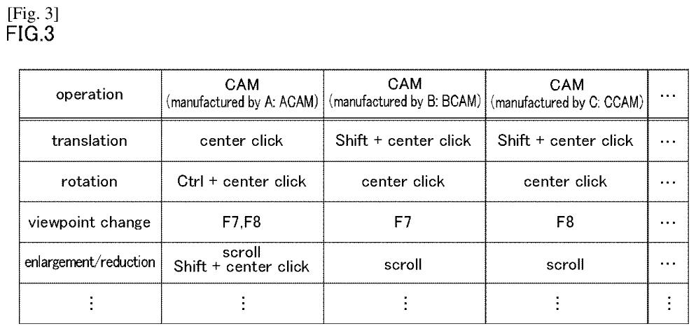

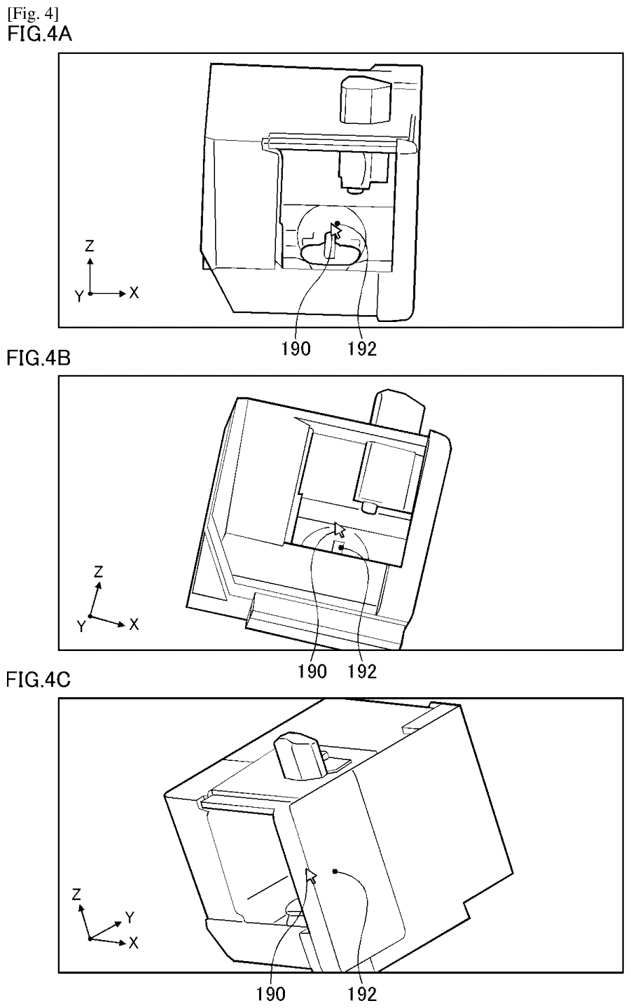

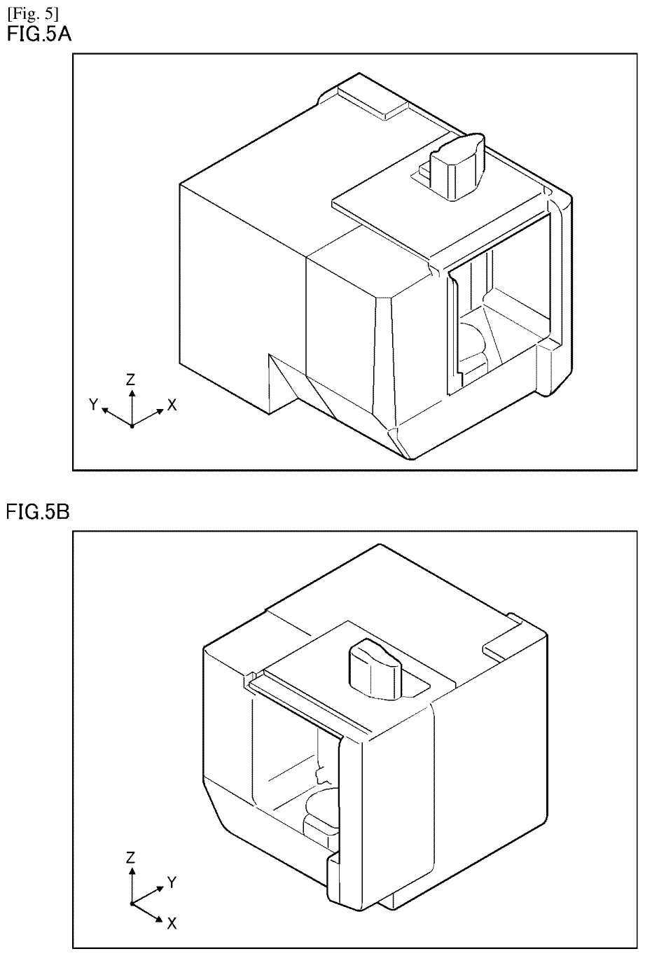

FIG. 3 illustrates an example of the differences in operability depending on the type of CAM. FIGS. 4A to 4C, 5A and 5B illustrate one example of operations to change the display mode of an image. FIGS. 4A to 4C, 5A and 5B illustrate the process of the change.

In a case where a three-dimensional image based on model data is displayed on the display screen of the CAM, the user performs display operations such as translation, rotation, viewpoint change, and enlargement/reduction of the image object by using a keyboard, mouse, touch panel, or the like as the input unit 150 in order to confirm points of interest. However, the input format (input operation) for each display operation may differ depending on the type of CAM.

“Translation” in FIG. 3 indicates a display operation of translating an image object upward, downward, leftward, or rightward on the screen. “Rotation” indicates a display operation of rotating an image object around a predetermined fixed point (rotation center). “Viewpoint change” indicates a display operation of changing the view from one of the front view, rear view, top view, bottom view, right-side view, and left-side view of an image object to another. “Viewpoint change” also includes display operations of changing the isometric viewpoint of an isometric image (isometric view) of an image object. “Enlargement/reduction” indicates a display operation of enlarging or reducing an image object with respect to a predetermined fixed point (reference point).

For example, for three types of CAMs: ACAM, BCAM, and CCAM, there is a difference in user input operations to perform each display operation (i.e., difference in operability). Regarding to translation, in ACAM, a user can translate images by clicking on the center of the image (center click only) and moving the cursor while holding that state. In the BCAM and CCAM, on the other hand, a user can translate images by holding down the Shift key and clicking in the center of the image (Shift+center click), then moving the cursor while holding that state.

Regarding to rotation, as shown in FIGS. 4A to 4C, in ACAM, a user can rotate images by holding down the Ctrl key, placing the cursor 190 in the center of the image, clicking the image (Ctrl+center click), and moving the cursor 190 around a rotation center 192 while holding the state. On the other hand, in BCAM and CCAM, a user can rotate images by clicking the center of the image (center click only) without pressing the Ctrl key and moving the cursor 190 around the rotation center 192 while holding the state.

Regarding to viewpoint change, in ACAM, a user can change the viewpoints sequentially with each press of F7 key or F8 key. Specifically, a user can change the viewpoints sequentially in the forward direction by pressing F7 key and in the reverse direction by pressing F8 key. In BCAM, on the other hand, a user can change the viewpoints sequentially with each press only in the forward direction by pressing F7 key. In CCAM, a user can change the viewpoints sequentially with each press only in the forward direction by pressing F8 key. For example, an image can be displayed at a specific isometric viewpoint, as shown in FIG. 5A. Then, by pressing the F7 or F8 key, the isometric viewpoint can be further rotated by +/−90 or 180 degrees around any of the X, Y or Z axes to display another viewpoint, as shown in FIG. 5B.

Regarding to enlargement/reduction (scaling), in ACAM, a user can enlarge or reduce the image by holding down the Shift key and clicking in the center of the image (Shift+center click), then conducting scroll operation while holding that state. Each direction of scrolling corresponds to enlargement/reduction. On the other hand, in BCAM and CCAM, the image can be enlarged or reduced only by scrolling.

Thus, the input operation (operability) for changing the display mode of the three-dimensional image may differ depending on the type of CAM. With regard to this, considering the convenience of the user, it is desirable that the operation of CAM can be inherited by the post-processor. Therefore, in this embodiment, according to the selection by the user, the operability of the screen when using the post-processor is changed to the operability of the CAM, which is the output source of the CL data. The followings are the details of this process.

The operability storage unit 144 stores a table (hereinafter also referred to as the “operability table”) which indicates the correspondence between the input operation and the display operation depending on the CAM specific information (i.e., for each type of CAM) as shown in FIG. 3.

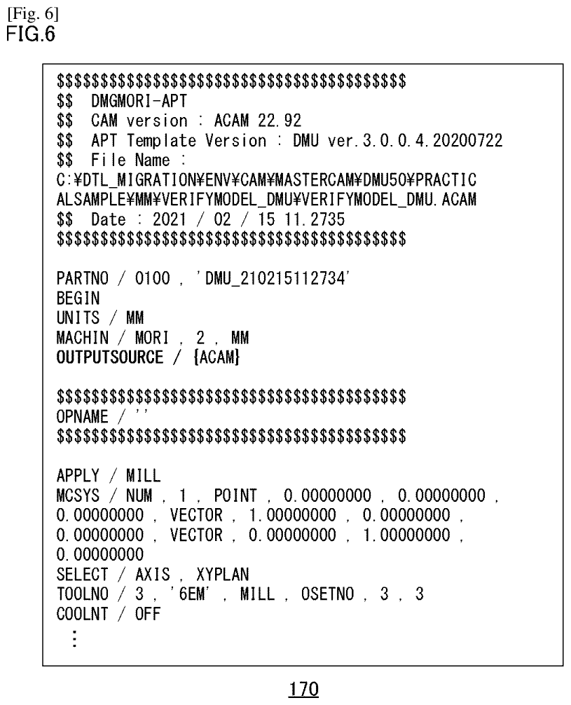

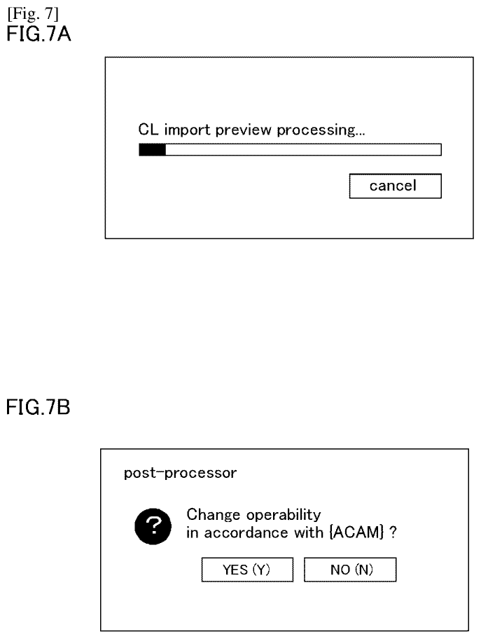

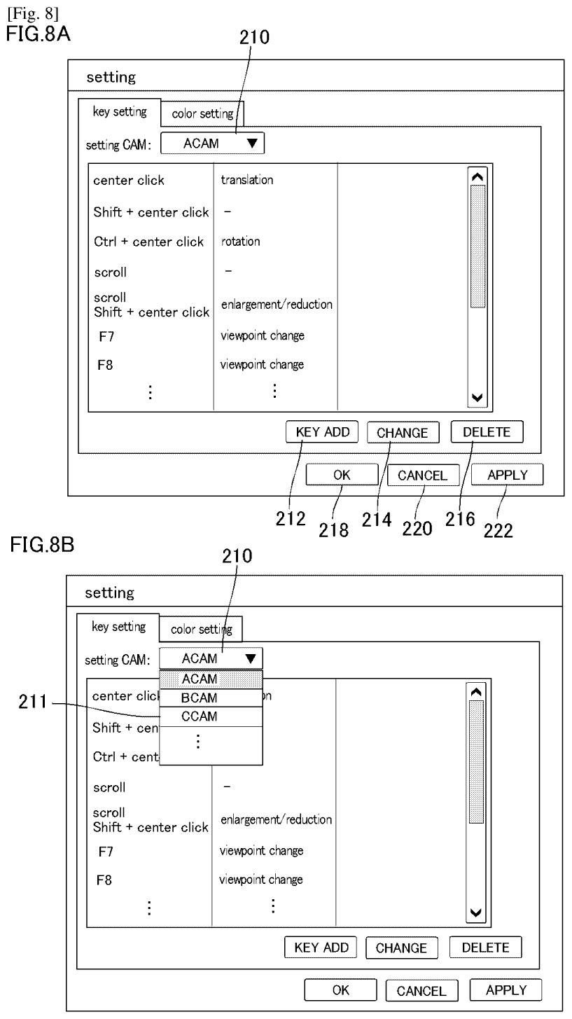

FIGS. 6 to 8B illustrate specific examples of operability change processing. FIG. 6 illustrates an example of CL data. FIGS. 7A and 7B illustrate a processing screen when importing CL data. FIGS. 8A and 8B illustrate an operation screen for changing operability manually.

As shown in FIG. 6, in this embodiment, the specific information is incorporated into the CL data in the CAM device 160 to enable the above-described change in operability. The example shown in the figure incudes, in a predetermined block in the CL data written in the APT (Automatically Programmed Tool) language, the description of “OUTPUTSOUECE/{ACAM}” (sec, bold characters). The description in the { } is the CAM name included as the specific information. In the example shown in the figure, “ACAM” is exemplified, but if the output source of the CL data is BCAM, the description will be “BCAM”, and if it is CCAM, the description will be “CCAM”.

When CL data is imported from the CAM device 160 to the information processing device 100, the import preview screen shown in FIG. 7A is displayed. At this time, the specific information acquisition unit 132 extracts the specific information from the CL data acquired by the data acquisition unit 124 and stores it in the specific information storage unit 142.

When the import is completed, the operability selection screen shown in FIG. 7B is displayed. This operability selection screen is a screen allowing the user to select whether or not the post-processor inherits the operability related to the CAM screen display and also displays the CAM name specified from the specific information. The user selects one of the buttons of “Yes” or “No” on the operability selection screen.

If “Yes” is selected, the operability of the screen display in the post-processor is set or changed to the operability of the CAM. If “No” is selected, the operability of the post-processor will remain at its default setting without changing to the operability of the CAM. In this embodiment, the default setting is a unique setting that does not depend on the type of CAM; however, the default setting may be the operability of CAMs having a high market share. An operability common to multiple CAMs may be given priority.

In the present embodiment, this operability can also be set or changed afterwards. That is, when a user selects a setting button (not shown) displayed on the execution screen of the post-processor, the setting screen (dialog box) illustrated in FIGS. 8A and 8B is displayed, which allows the user to set or change the operability.

In the example shown in the figure, the “key setting” tab of the setting screen is selected, so that the key setting screen is displayed (FIG. 8A). On the key setting screen, CAM SELECT button 210, KEY ADD button 212, CHANGE button 214 and DELETE button 216 are provided. The CAM SELECT button 210 is used to select the operability for each CAM at once, and one of the CAMs can be selected from the pull-down menu 211 (FIG. 8B).

In FIG. 8A, ACAM is selected from the several types of CAM, and the correspondence between the input operation and the display operation shown in FIG. 3 is shown. The user can use the ACAM operability without change, but can add his/her own operability settings by selecting the KEY ADD button 212. In addition, one of the already set input operations can be changed by selecting the CHANGE button 214. Further, any of the already set operability can be deleted by selecting the delete button 216.

In addition, OK button 218, CANCEL button 220, and APPLY button 222 are provided on the setting screen. After the user has added, changed, or deleted any input operation, the addition, change, or deletion can be confirmed by selecting the APPLY button 222 and then selecting the OK button 218. The addition, change, or deletion can be canceled by selecting the CANCEL button 220. When an operability of one of several CAMs is to be inherited without change, the user may select a desired CAM displayed in the pull-down menu 211 and then sequentially select the APPLY button 222 and the OK button 218.

Next, the flow of the operability setting process is described.

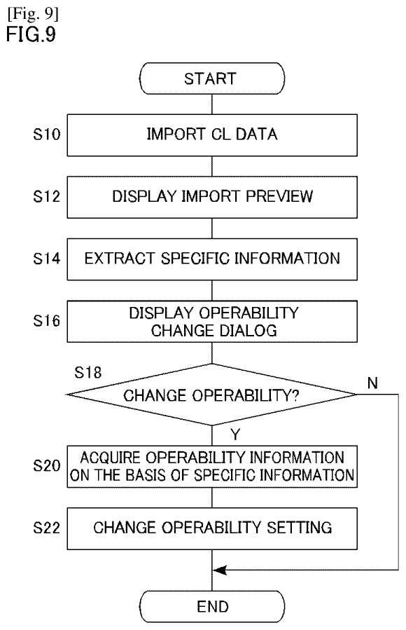

FIG. 9 is a flowchart showing an operability setting process.

As described above, the information processing device 100 imports CL data from the CAM device 160 in accordance with a user input (S10). At this time, the display control unit 134 causes the display unit to display the import preview screen shown in FIG. 7A (S12). The specific information acquisition unit 132 extracts specific information from the CL data and stores it in the specific information storage unit 142 (S14).

When the import of the CL data is completed, the display control unit 134 causes the display unit to display the operation change dialog shown in FIG. 7B (S16). At this time, if the user selects to change the operability (i.e., if “yes” is selected) (Y in S18), the operability setting unit 136 refers to the operability table on the basis of the specific information and acquires the operability information of the corresponding CAM (S20). Then, the operability setting unit 136 sets the operability of the post-processor so as to reflect the acquired operability information (S22). If the user does not select to change the operability (i.e., if “No” is selected) (N in S18), S20 and S22 are skipped.

The information processing device 100 has been described above on the basis of an embodiment.

The information processing device 100 of this embodiment changes the display mode of the three-dimensional image on the basis of the model data acquired from the CAM device 160 in accordance the with user request. The operability of the input unit 150 for the screen display function of the post-processor can now be changed according to the operability of the CAM on the basis of the specific information extracted from CL data. Specifically, the operability setting unit 136 changes the operability of the input unit 120 so that the operation for image translation is conformed to the operation for image translation in the CAM and the operation for image rotation is conformed to the operation for image rotation in the CAM. Therefore, even in a case when the CAM user uses the post-processor without customization procedure, it is possible to commonalize the operability in the image display, thereby enhancing the work efficiency of the user. In other words, the post-processor can provide the same operating feeling as CAM, thereby facilitating operation by the user.

Although an embodiment of the present invention has been described above, the present invention is not limited to the embodiment, and it goes without saying that various modifications are possible within the scope of the technical concept of the present invention.

### Modifications

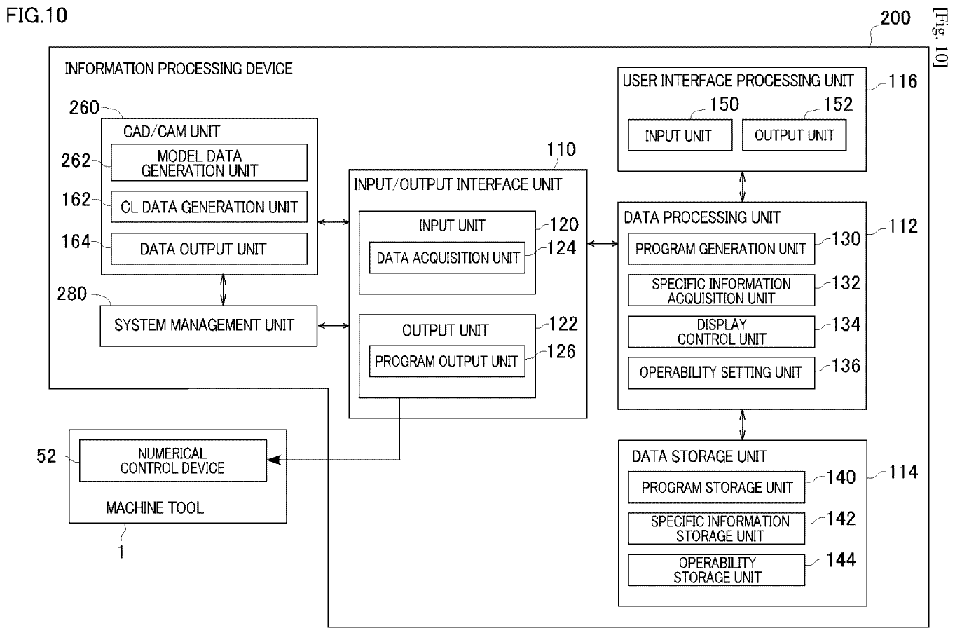

FIG. 10 is a functional block diagram of an information processing device 200 according to a modification.

The above embodiment exemplifies a configuration in which the CAM device 160 and the information processing device 100 are independent. In this modification, the CAD, CAM, and post-processor are incorporated in a common personal computer (PC).

The information processing device 200 includes a CAD/CAM unit 260 and a system management unit 280. The CAD/CAM unit 260 has both CAD and CAM functions and includes a model data generation unit 262, the CL data generation unit 162, and the data output unit 164. The model data generation unit 262 generates model data (CAD data) by the CAD function. The CL data generation unit 162 generates CL data on the basis of the CAD data and path generation information. The data output unit 164 outputs model data and CL data to the information processing device 100.

The system management unit 280 performs file management of software that implements each function of the information processing device 200. The system management unit 280 can check the software installed in the information processing device 200 by referring to the system file of the information processing device 200. In this modification, when a post-processor is installed, the specific information acquisition unit 132 inquires the system management unit 280 to acquire specific in-formation indicating the type of CAM.

When the installation of the post-processor is completed, the display control unit 134 causes the display unit to display the operation change dialog shown in FIG. 7B. In this case, if the user selects to change the operability, the operability setting unit 136 acquires the operability information of the corresponding CAM from the operability storage unit 144 on the basis of the specific information and sets the operability of the post-processor so as to reflect the acquired operability.

According to this modification, the operation of the post-processor can be changed according to the operation of the CAM on the occasion of the installation of the post-processor. As a result, the same effect as the above embodiment can be achieved. That is, the post-processor can achieve the same operating feeling as the CAM, thereby facilitating operation by the user.

When a CAD/CAM program is installed after the installation of the post-processor, the specific information acquisition unit 132 may acquire the specific information of the CAM on the occasion of the installation of the CAD/CAM program as described above. Then, the operability of the post-processor may be changed according to the user input.

This modification exemplifies an example of using the file management function by the system management unit 280, but a process monitoring function can also be utilized. That is, the active CAM may be detected by process monitoring and the specific information of the CAM may be acquired.

### Other Modifications

In the above embodiment, an example of changing the operability of the post-processor is shown for the operability when changing a display mode of a three-dimensional image based on model data. In the modified example, the operability may be changed similarly for the display mode of the two-dimensional image. The operability may also be changed in the same manner for simulated images of a manufacturing process based on the model data and the CL data. Furthermore, the operability may be changed in the same manner for a simulation image based on the NC program converted from CL data.

The above embodiment exemplifies a configuration in which operability of image display can be inherited in the relation between the CAM device and the information processing device. In a modification, the operability may be inherited in the relation between the external device and the machine tool (information processing device). The external device may be a CAD device or a CAD/CAM device.

When the external device is a CAD device, the operability of changing the display mode of a three-dimensional image or a two-dimensional image based on the model data can be inherited by the information processing device incorporated in the machine tool as in the above embodiment. The information processing device may include a numerical control device, and those images may be displayed on a viewer or the like.

If the external device is a post-processor of the CAM device, the operability of changing the display mode of the image in the information processing device of the machine tool may be changed so as to be conformed to the operability of the CAM device. The image may include a three-dimensional or two-dimensional image based on model data. Also, simulation images based on NC programs and model data may be included.

Specific information may be transmitted from an external device to an information processing device of a machine tool by file transfer. A post-processor constituting the external device may send specific information in the form of an operability definition file conforming to the settings of the CAM. Alternatively, data (job data) containing, as specific information, identifying information such as a CAM name may be transmitted. An information processing device of a machine tool may request specific information from an external device, and the external device may transmit specific information accordingly. A network shared folder between the external device and the machine tool may be provided to store specific information.

Alternatively to the above embodiment in which the CAD device and the CAM device are separately configured, a CAD/CAM device having both CAD and CAM functions may be provided.

Although the information processing device is a post-processor in the above embodiment, the information processing device may be a second CAD/CAM device (CAD/CAM device-2). For example, it is assumed that an NC program generated by CAD/CAM-1 installed in PC-1 is loaded into CAD/CAM-2 of PC-2. In such a case, the operability may be changed by the method of the above embodiment or modification in order for CAD/CAM-2 to inherit the operability of CAD/CAM-1. Instead of the second CAD/CAM device, CAM device-2 having no CAD function may be employed.

In the above embodiment, the machine tool is exemplified as a machining center that moves a rotating tool relative to a workpiece; however, the machine tool can be a turning center that moves a tool relative to a rotating workpiece or can be an additional processing machine that laminates materials while melting them with a laser. In addition, the machine tool may be a combined processing machine having these functions in combination.

Although not described in the above embodiment, the information processing program described above may be recorded in/on and provide as a computer-readable recording medium.

The present invention is not limited to the embodiments described above and modifications thereof, and any component thereof may be modified and embodied without departing from the scope of the invention. Components described in the embodiments and modifications may be combined as appropriate to form various embodiments. Some components may be omitted from the components presented in the embodiments and modifications.

This application claims priority from Japanese Patent Application No. 2022-020153 filed on Feb. 14, 2022, the entire contents of which are hereby incorporated by reference herein.

1. An information processing device that generates NC programs used in machine tools, comprising:
a data acquisition unit that acquires model data or CL data output from a CAM;
a specific information acquisition unit that acquires specific information of the CAM;
a program generation unit that generates the NC program on the basis of the CL data;
an input unit that accepts user input;
a display control unit that displays one of a simulation image, a three-dimensional image, and a two-dimensional image on the basis of at least one of the NC program, the model data, and the CL data, and changes a display mode of the displayed image according to the user input; and
an operability setting unit that changes the operability of the input unit for changing the display mode of the displayed image according to the operability of the CAM on the basis of the specific information acquired by the specific information acquisition unit.

2. The information processing device according to claim 1, wherein the specific information is included in the CL data.

3. A machine tool, comprising:
a data acquisition unit that acquires model data and NC programs generated by an external device;
a specific information acquisition unit that acquires specific information of the external device;
an input unit that accepts user input;
a display control unit that displays one of a simulation image, a three-dimensional image, and a two-dimensional image on the basis of at least one of the NC program and the model data, and changes a display mode of the displayed image according to the user input; and
an operability setting unit that changes the operability of the input unit for changing the display mode of the displayed image according to the operability of the external device on the basis of the specific information acquired by the specific information acquisition unit.

4. An information processing program that generates an NC program used in a machine tool,
the information processing program causing a computer to implement:
a function to acquire model data or CL data output from a CAM;
a function to acquire specific information of the CAM;
a function to generate the NC program on the basis of the CL data;
a function to accept user input via an input unit;
a function to display one of a simulation image, a three-dimensional image, and a two-dimensional image on the basis of at least one of the NC program, the model data, and the CL data, and change the display mode of the displayed image according to the user input; and
a function to change the operability of the input unit for changing the display mode of the displayed image according to the operability of the CAM on the basis of the acquired specific information.
